(19) United States
(12) Patent Application Publication
(10) Pub. No.: US 2025/0383320 A1
(43) Pub. Date: Dec. 18, 2025

(54) Method and Device for Stray Flux Testing of Ferromagnetic Test Material With Signal Normalization

(71) Applicant: Institut Dr. Foerster GmbH & Co. KG, Reutlingen (DE)

(72) Inventors: Frank EIBOFNER, Moessingen (DE); Friedrich HECKER, Reutlingen (DE)

(21) Appl. No.: 18/879,583

(22) PCT Filed: Jun. 21, 2023
(86) PCT No.: PCT/EP2023/066730

§ 371 Date: Dec. 27, 2024

(30) Foreign Application Priority Data
Jun. 30, 2022 (DE) 10 2022 206 680.4

(51) Int. Cl. G01N 27/87

(52) U.S. Cl. CPC G01N 27/87

(57) ABSTRACT

A method for leakage flux testing of ferromagnetic test material in order to detect defects, includes: magnetizing a test volume of the test material by an external magnetic field to generate a magnetization state of the test volume that can be characterised by a magnetization, and scanning a surface of the test material by a probe arrangement having at least one magnetic-field-sensitive leakage flux probe for detecting leakage magnetic fields caused by defects. The leakage flux probe is held at a finite test distance from the surface of the test material during the scanning, and generates electrical probe signals which are a measure of the leakage field strength. The method determines the magnetization state of the test volume in the region of the leakage flux probe using at least one magnetic field probe to generate magnetization signals, which represent a measure of the magnetization state of the test material in the region of the leakage flux probe, by normalizing the probe signals by the assigned magnetization signals in order to determine normalized probe signals, and by evaluating the normalized probe signals to qualify the defects.

### FIELD OF APPLICATION

The invention relates to a method for the leakage flux testing of ferromagnetic test material in order to detect defects, and also to an apparatus suitable for carrying out the method.

### BACKGROUND AND SUMMARY

In the context of the non-destructive testing of semifinished products and finished parts for defects, magnetic leakage flux methods are an important component for monitoring quality both in the process for production and during the cyclically recurring testing of the finished parts. Magnetic leakage flux methods are less sensitive to some disturbing properties of the materials, such as, for example, roughness of the surface or scale coating in the case of hot-rolled products, than the eddy current method or ultrasonic testing, for example. This results in a better ratio between signal used and noise signal (S/N ratio), as a result of which more reliable fault identification is made possible.

In an apparatus for detecting defects by means of leakage flux measurement, a test volume of the test specimen is magnetized by means of a magnetization device and scanned with the aid of at least one magnetic field-sensitive leakage flux probe in order to detect magnetic leakage fields caused by the defects. A relative movement between the leakage flux probe and the surface of the test material in a scanning direction takes place in this case. During the scanning, the leakage flux probe is held at a relatively small, but finite, test distance from the surface of the test material.

The magnetic flux generated by the magnetization device in the test material, or the magnetic field, is spatially distributed substantially homogeneously in the defect-free material. In this case, no significant magnetic field gradients occur in the regions near the surface either. Cracks and other defects, such as e.g. cavities, inclusions, or other inhomogeneities such as e.g. weld seams, etc., act as regions of increased magnetic reluctance, and so field components in the vicinity of a defect are guided around the defect and forced out from the metal into the region near the surface. The field components forced out are detected in the leakage flux methods for detecting the defects. In a leakage flux measurement, a defect is detectable when the field components displaced from the test specimen reach as far as the region of the leakage flux probe and bring about there a change in the field that is sufficient for the detection.

The electrical probe signals, i.e. the electrical signals of the leakage flux probe, or signals derived therefrom, are evaluated by means of an evaluation device in order to qualify the defects.

The testing of pipes involves endeavouring to detect both external faults, i.e. faults or defects on the exterior side of the pipe, and internal faults, i.e. faults on the interior side of the pipe and also faults in the pipe wall. Methods with DC field magnetization (DC leakage flux testing) are normally used for this purpose. A significant advantage of the DC field magnetization is utilized here, namely the large penetration depth, such that internal faults and faults in the pipe wall can also be detected.

Test material in the form of rods can likewise be tested. AC field magnetization is generally employed in rod testing (AC leakage flux testing).

DE 10 2014 212 499 A1 discloses generic methods and apparatuses for the leakage flux testing of ferromagnetic pipes that allow a reliable identification of faults independently of length and angle and a precise differentiation between external and internal faults. The probe arrangement has a probe array comprising a multiplicity of magnetic field-sensitive probes arranged next to one another in a width direction. Use of a probe array enables the test width covered during a scanning process to be significantly greater than the test width covered by a single probe. In this case, the spatial resolution in the width direction is determined by the probe width of the individual leakage flux probes. Use of probe arrays enable efficient testing of test specimens in a continuous method.

Pipes and rods should be tested as completely as possible. It is normal, however, for portions of greater or lesser length at the ends to remain untested over the entire test part length in test specimens. These portions, the so-called “untested ends”, have to be tested or cut off manually or in an automated manner by means of additional equipment, and discarded. Each of these options causes additional processing times and losses for the manufacturer.

Against this background, a problem addressed by the invention is that of providing a method and an apparatus for leakage flux testing which enable a reliable qualification of defects even in cases where magnetization of the test specimen is difficult to control. In particular, the intention is to achieve a reduction of untested ends to the greatest possible extent when testing ferromagnetic pipes or rods.

In order to solve this problem, the invention provides a method and also an apparatus having the features of the independent claims. Advantageous developments are specified in the dependent claims. The wording of all the claims is incorporated by reference in the content of the description.

In the method according to the claimed invention, a test volume of the test material is magnetized with the aid of an external magnetic field in order to attain a magnetization state of the test volume that can be characterized by the magnetization thereof. The magnetization is a physical variable for characterizing the magnetic state of a material. It is a vector field that describes the density of permanent or induced magnetic dipoles in a magnetic material, and is calculated as magnetic moment per volume.

In the method, a surface of the test material is scanned by means of a probe arrangement having at least one magnetic field-sensitive leakage flux probe in order to detect magnetic leakage fields caused by defects. During the scanning, the leakage flux probe is held at a finite test distance from the surface of the test material and generates electrical probe signals that are a measure of the strength of the leakage field at the location respectively scanned.

According to the claimed invention, the magnetization state of the test volume in the region of the leakage flux probe is additionally determined or ascertained. At least one magnetic field probe which generates magnetization signals that represent a measure of the magnetization state of the test material in the region of the leakage flux probe is utilized for this purpose. The probe signals are normalized by means of the assigned magnetization signals in order to ascertain normalized probe signals. The normalized probe signals are then evaluated in order to qualify the defects.

An apparatus according to the claimed invention is distinguished by the fact that the probe arrangement has at least one magnetic field probe in order to generate magnetization signals that represent a measure of the magnetization state of the test material in the region of the leakage flux probe. The evaluation device is configured to carry out a normalization of the probe signals by means of the assigned magnetization signals in order to generate normalized probe signals, which can then be evaluated in order to qualify the defects.

The invention is based on the following insights and considerations of the inventors, inter alia. In the case of ideal testing, the signal amplitude of the probe signals of a leakage flux probe upon detection of a fault (also called fault signal amplitude hereinafter) should be dependent only on the geometry and position of a fault or of the defect, such that the type and extent of the fault, for example the fault depth, etc., can be reliably established on the basis of the fault signal amplitude. At all events, fault signals should be able to be compared among one another, such that mention can be made of a relatively uniform test sensitivity independently of the location of the fault.

However, it was established that the fault signal amplitude essentially also depends on the magnitude of the magnetization in the material in the region of the test volume. However, this magnetization can be controlled only to a limited extent such that the test specimen is magnetized uniformly over its entire length. In conventional apparatuses and methods, this prevents or adversely affects a reliable interpretation of fault signals and, during the testing of ferromagnetic pipes or rods, for example, has the effect that fault signals cannot be assessed with sufficient certainty particularly in the regions of the ends of the test material. Relatively long untested ends may remain as a result.

According to the inventors' proposal, this problem is reduced or eliminated by the magnetization state of the test volume in the region of the leakage flux probe being determined metrologically using at least one magnetic field probe which can generate magnetization signals that represent a measure of the magnetization state of the test material in the region of the leakage flux probe. The probe signals are then normalized by means of the assigned magnetization signals in order to ascertain normalized probe signals. The latter are then evaluated in order to qualify the defects.

The normalization with the aid of the magnetization signals enables the fault signals or the probe signals of the leakage flux probe to be made comparable among one another, even if there are different defects in regions having different magnetization strengths. A sufficiently uniform test sensitivity can thus be produced by continuously detecting the magnetization state and normalizing or compensating for the fault signal amplitude with this magnetization state. Consequently, it is possible to considerably reduce the variation of the test sensitivity depending on the magnetization that is effective in the test volume in comparison with the prior art, and if appropriate to suppress said variation to such an extent that a uniform test sensitivity that is sufficient for the test purposes can be assumed during testing.

In many embodiments, a magnetic field probe is a separate magnetic field-sensitive probe provided in addition to a leakage flux probe, that is to say a separate functional element arranged in a suitable spatial relationship with respect to at least one assigned leakage flux probe. The leakage flux probe and the at least one magnetic field probe can then be arranged optionally at a distance from one another in each case at a position which is optimal for their measurement task. Moreover, the signal transmission and evaluation can be optimized separately for both types of probe. The same probe principle can be utilized (e.g. Hall probe) but the probes can also operate according to different principles (e.g. induction probe and Hall probe).

However, it is also possible for a leakage flux probe to simultaneously perform the function of a magnetic field probe. Consequently, a magnetic field probe need not be provided in addition to a leakage flux probe. Rather, a leakage flux probe can also be used as a magnetic field probe. This integration makes use of the insight that one and the same magnetic field-sensitive probe can fulfil both tasks, since the probe signal contains both signal components attributed to the detection of a fault and signal components representing the magnetization to be measured. These signal components (fault signal component and magnetization signal component) can be separated from one another for the evaluation. The signal component separation can be realized by way of electronic filter components or by way of filter algorithms. This is possible since, during continuous testing, the fault signal components are in a range of relatively high frequencies, while the magnetization signal components are at low frequencies.

In accordance with one development, the apparatus has at least one test head in which a probe arrangement comprising at least one leakage flux probe and also comprising at least one magnetic field probe are arranged or mounted in a fixed spatial relationship with respect to one another. As a result, a compact set-up can be achieved and the assignment between leakage flux probe and assigned magnetic field probe (at least one, often also a plurality) remains practically unchanged without further measures during operation, as a result of which permanently reliable results can be attained.

It is possible, in principle, to arrange a magnetic field probe outside the test head. However, the detected magnetization state should be representative of the location of the leakage flux probe to be compensated for. The best way of implementing that is by way of a spatial proximity and also the smallest possible gradient of the magnetization state between magnetic field probe and leakage flux probe. Preference is therefore given to accommodating magnetic field probes in the test head.

In many cases the situation is such that the leakage flux probe is arranged with its main sensitivity direction such that a normal component of the leakage field that is oriented perpendicularly to the surface of the test specimen can be detected with high sensitivity.

In contrast thereto, it is preferably provided that in order to ascertain the magnetization state, a parallel component of the magnetic field is measured in a close range around the leakage flux probe. The parallel component is that component which is directed substantially parallel to the surface of the test material and substantially parallel to the main magnetization direction or to the field lines of the magnetization field. The magnetic field probe can thus be aligned with its main sensitivity direction more or less orthogonally to the surface normal oriented perpendicularly to the surface of the test specimen, and/or to the main sensitivity direction of the leakage flux probe.

As an alternative or in addition thereto, a leakage flux probe can also detect the change in the parallel component of the leakage field. In this case, the main sensitivity directions of leakage flux probe and magnetic field probe would lie in one plane, optionally parallel to one another.

Preferably, in order to detect the magnetization state, a magnetic field component directed substantially parallel to the surface of the test material and to the main magnetization direction (the parallel component) is measured.

The parallel field corresponds to that component of the magnetic field strength at the test material surface which extends parallel to the test material surface. During longitudinal fault testing where the main magnetization direction of the magnetization field extends substantially in a circumferential direction of the test material, the parallel component extends in a plane that is perpendicular to the longitudinal axis of the test material. In this case, in this application, the parallel component is also referred to as tangential component. A measurement of the tangential field is advantageous particularly if the test material is a ferromagnetic pipe.

During transverse fault testing where the main magnetization direction of the magnetization field extends substantially in a longitudinal direction or axial direction of the test material, the parallel component extends substantially parallel to the longitudinal axis of the test material. In this case, the parallel component may also be referred to as axial component.

The designations “substantially parallel” or “substantially tangentially” mean that small deviations from the mathematically exact directions are possible, e.g. by a maximum of 20° or a maximum of 15° or a maximum of 10°.

The magnetic field measurement by way of magnetic field components extending parallel to the test specimen surface outside the test specimen takes account of the fact that the magnetization in a test specimen cannot be measured directly. In the case of pipe testing, it has been found that the magnetization in the pipe wall can be derived particularly well by way of the parallel component, in particular by way of the so-called tangential field or T-field. The proportionality factor between the magnetization of the test material and the parallel field or the tangential field directly at the pipe surface corresponds to the ratio of the magnetic permeabilities of air and the pipe material. The magnetization state in the test volume detected by the leakage flux probe can thus be ascertained to a good approximation by measurement of the magnetic field component in the close range around the leakage flux probe.

It may be advantageous to measure, in addition to the parallel component oriented parallel to the main magnetization direction, also a parallel component extending orthogonally or obliquely thereto. As a result, a two-dimensional magnetic field measurement is realized. The latter may be advantageous e.g. in order to normalize fault signals under non-ideal magnetization conditions and/or in order to characterize oblique faults.

If the (at least one) magnetic field probe is provided in addition to the (at least one) leakage flux probe, it can be offset with respect thereto both in a radial direction and in an axial direction relative to the location of the leakage flux probe; this offset can be taken into account in the interpretation of the fault signals.

As an alternative thereto, both the leakage flux signals and the magnetization signals can be recorded by the same probe. In this case, a magnetic field-sensitive probe positioned at a finite test distance from the surface of the test material detects both the DC field and the AC field components of the magnetic field in the direction of the main magnetization direction. The downstream signal processing device separates the signal thus detected into an only slowly varying DC field component and the AC field component superposed thereon. In the downstream processing, the DC field component represents the magnetization state, and the AC field component the probe signals, which is a measure of the strength of the leakage field caused by defects at the scanned location.

It is particularly advantageous in many cases if the leakage flux probe and the magnetic field probe are based on the same measurement principle and are installed merely with a different orientation of the sensitivity direction. By way of example, the leakage flux probe and the magnetic field probe can each be a Hall element.

Preferably, a (optionally slowly varying) DC field component of the magnetization signal is ascertained and utilized for normalizing the probe signal. It has been found that this component correlates particularly reliably with the present magnetization strength in the detected region of the test specimen.

In order to achieve efficient testing with optionally high spatial resolution adapted to the testing task, in preferred embodiments it is provided that the probe arrangement has a probe array comprising a multiplicity of leakage flux probes arranged next to one another in a straight series in a first direction. Preferably, two or more magnetic field probes arranged at a distance from one another in a straight series parallel to said first direction are then provided in order to detect the magnetization state. It may also be sufficient to utilize only one magnetic field probe.

In this case, the number of magnetic field probes can be distinctly less than the number of leakage flux probes, such that not every leakage flux probe need be assigned a dedicated magnetic field probe. Rather, the situation may be such that the magnetization acting at the location of a specific leakage flux probe can be derived in each case by interpolation from the magnetization signals detected by a plurality of magnetic field probes. In some embodiments, there are at least ten times as many leakage flux probes as magnetic field probes, as a result of which, firstly, a sufficient spatial resolution of the leakage flux testing can be attained and, secondly, the equipment outlay for magnetic field measurement can be limited.

It is preferred for the leakage flux probes to be arranged on a side of the probe arrangement that is to be directed towards the test specimen, and for the magnetic field probe(s) to be arranged at a distance behind the leakage flux probes, that is to say at a somewhat greater distance from the test material. As a result, a high spatial resolution of the fault detection by means of leakage flux measurement can be combined with sufficiently accurate detection of the magnetization state at the individual leakage flux probes.

In some embodiments, the leakage flux probes are arranged at uniform distances from one another, and the magnetic field probes are arranged at non-uniform distances from one another, a density of magnetic field probes preferably being greater in end regions of the probe arrangement than in a central region of the probe arrangement. That may be advantageous, if appropriate, for the measured value detection in the region of the test specimen ends.

In preferred embodiments, it is provided that the probe signal of a leakage flux probe has a signal amplitude, and that in order to normalize the probe signal, the signal amplitude is multiplied by a compensation factor that at least partly compensates for a magnetization dependence of the test sensitivity. Such a multiplication operation can be carried out relatively rapidly simultaneously for many leakage flux probes in the context of the evaluation. The compensation factor may for example tend to be inversely proportional to the strength of the magnetization of the test volume scanned by the leakage flux probe.

In preferred methods and apparatuses, suitable compensation factors are not estimated on the basis of theoretical relationships, but rather ascertained very precisely on the basis of measurements and tested extrapolations and/or interpolations. In some methods, calibration measurements are carried out on a correlation portion of the test specimen, said correlation portion being equipped with at least one correlation fault, in order to ascertain a compensation curve that describes a functional relationship between a magnetization state of the test specimen in the case of external magnetic fields of different strengths, corresponding magnetization signals of a magnetic field probe and a signal amplitude of the probe signal that is generated by the correlation fault. During the evaluation of the probe signals, compensation factors for normalizing probe signals are then derived from the compensation curve. The term “correlation fault” here describes a standard defect, the width and depth of which are generally predefined by standards in order to enable comparable test results.

In order to achieve the effect that identical faults at different longitudinal positions of a test material, for example of a ferromagnetic pipe to be tested, generate the same probe signal, the magnetization would have to be constant across the length of the test material. However, it was established that primarily at the pipe ends or in the end regions of a test specimen, the actual magnetization can deviate considerably from the magnetization in the central region of the test material. Even wall thickness variations, such as, for example, manufacturing-dictated polygons or eccentricities, and for example an eccentric position of a test material and also induction effects in the case of magnetic field changes have a great influence on the magnetization effectively present in the test volume.

Some methods involve taking account of a variation of the magnetization state depending on an axial position of a test portion to be tested when ascertaining the correction factor to be applied for the test portion by a procedure in which, when ascertaining the correction factor, an axial offset between the correlation portion and the test portion is ascertained and the correction factor is modified depending on this offset. What can thus be achieved is that an appropriate compensation of the fault signal amplitude is possible with relatively little computational complexity even if the calibration measurement or the correlation with a standard defect was not carried out in the axial position of the defect to be assessed later.

Sophisticated investigations by the inventors have shown that it is possible in many cases to ascertain the correction factor for an axial position in a test portion on the basis of a displaced compensation curve, the displaced compensation curve having the curve shape of the compensation curve ascertained in the calibration portion, and this compensation curve being displaced merely by a displacement value corresponding to the axial offset relative to the compensation curve ascertained in the calibration portion. On the basis of this permissive simplification, particularly rapid calibration measurements are possible in order to ascertain a locally correct compensation factor for each axial position on the test material.

Further advantages and aspects of the invention are evident from the claims and from the description of exemplary embodiments of the invention which are explained below with reference to the figures.

### BRIEF DESCRIPTION OF THE DRAWINGS

FIGS. 1A and 1B show subsystems of one exemplary embodiment of an apparatus for the leakage flux testing of ferromagnetic test material with a rotating subsystem (FIG. 1A) for testing for faults with a predominant component longitudinally with respect to the test material axis and a stationary subsystem (FIG. 1B) for testing for faults with a predominant component transversely with respect to the test material axis;

FIG. 2 shows fault type-specific leakage flux fields in a sectional view through a pipe;

FIG. 3 shows details concerning the design of the probe arrangement and also the main magnetization direction directed transversely with respect to the longitudinal axis of the pipe for a rotating subsystem in accordance with one exemplary embodiment;

FIG. 4 shows details concerning the design of the probe arrangement and also the main magnetization direction directed along the longitudinal axis of the pipe for a stationary subsystem in accordance with one exemplary embodiment;

FIGS. 5A to 5C show schematic progressions of magnetic field lines in different phases of continuous testing in order to elucidate differences in magnetization between pipe ends and pipe sensors;

FIG. 6 schematically shows the profile of the strength of the magnetization when a pipe passes through a test apparatus;

FIG. 7 shows a schematic side view of a test head in accordance with one exemplary embodiment with approximately 100 leakage flux probes and five assigned magnetic field probes;

FIG. 8 shows a schematic view of the arrangement illustrated in FIG. 7 in the longitudinal direction of a pipe during testing;

FIG. 9 shows a test head between two pole shoes, the magnetic field strength varying in an axial direction of the test head;

FIG. 10 shows a diagram illustrating the dependence of the measured and interpolated T-field on the location along the longitudinal direction of the test head;

FIG. 11 shows compensation curves for internal faults and external faults;

FIG. 12 shows the displacement of a compensation curve;

FIG. 13 shows the ascertainment of correction factors; and

FIG. 14 schematically shows the effect of the compensation on the fault signal amplitudes.

### DETAILED DESCRIPTION OF THE DRAWINGS

Exemplary embodiments of the claimed invention are explained below on the basis of an apparatus for the leakage flux testing of ferromagnetic test material in the form of hot-rolled ferromagnetic pipes in a continuous method. The apparatus is designed for the detection of defects or imperfections or discontinuities of various types and can reliably detect for example rolling faults both on the pipe interior side (internal faults) and on the pipe exterior side (external faults). In this case, longitudinal faults (faults with main direction of extent parallel to the pipe longitudinal axis) and transverse faults (faults with main direction of extent in the circumferential direction or perpendicular to the pipe longitudinal axis) and oblique faults (transversely with respect to the longitudinal direction and with respect to the circumferential direction) can be reliably found and characterized.

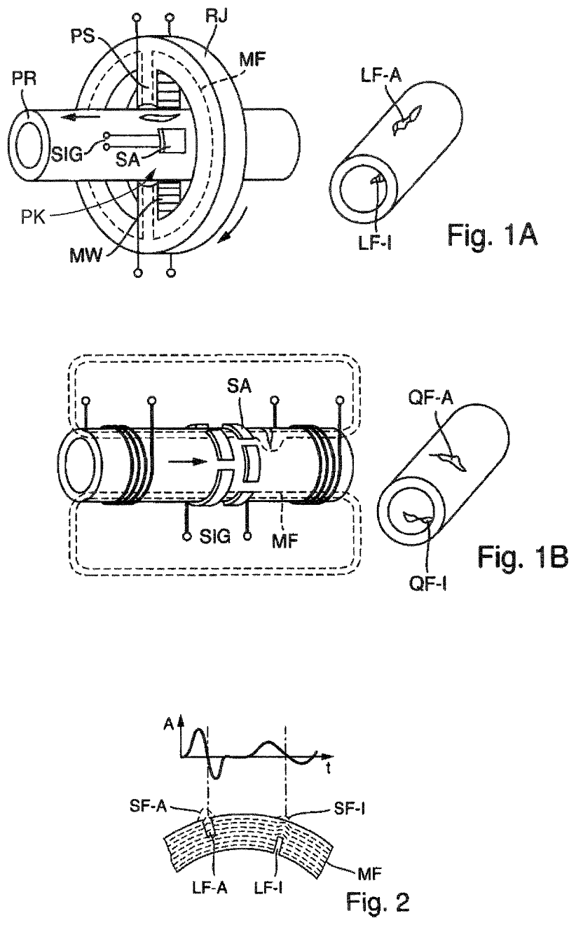

In one embodiment, two subsystems are integrated in a multi-test block. A rotating subsystem is provided for the longitudinal fault testing and its basic principle will be explained with reference to FIG. 1A. For the transverse fault testing, a stationary subsystem with a ring-shaped arrangement with a plurality of sensor arrays distributed around the circumference of the arrangement is provided, for example, according to the arrangement in FIG. 1B. The subsystems are arranged one behind the other in the passage direction of the pipe, in which case the order can be arbitrary. In other embodiments, not illustrated in more specific detail, a single system can be sufficient, e.g. a single rotating system.

The rotating subsystem has a rotary head with a ring yoke RJ rotating around the test material PR, said ring yoke having pole shoes PS aligned radially with respect to the test specimen surface at diametrically opposite points, magnetization windings MW being attached to said pole shoes. By this means, in the pipe wall, a magnetic flux or a magnetic field MF (DC field) is generated, the field lines of which extend in the circumferential direction of the test specimen, i.e. perpendicularly to the longitudinal direction of the pipe. On the rotor, test heads PK are arranged between the pole shoes in each case in the circumferential direction, said test heads each containing one or more probe arrays SO, each probe array comprising a multiplicity of individual leakage flux probes SO.

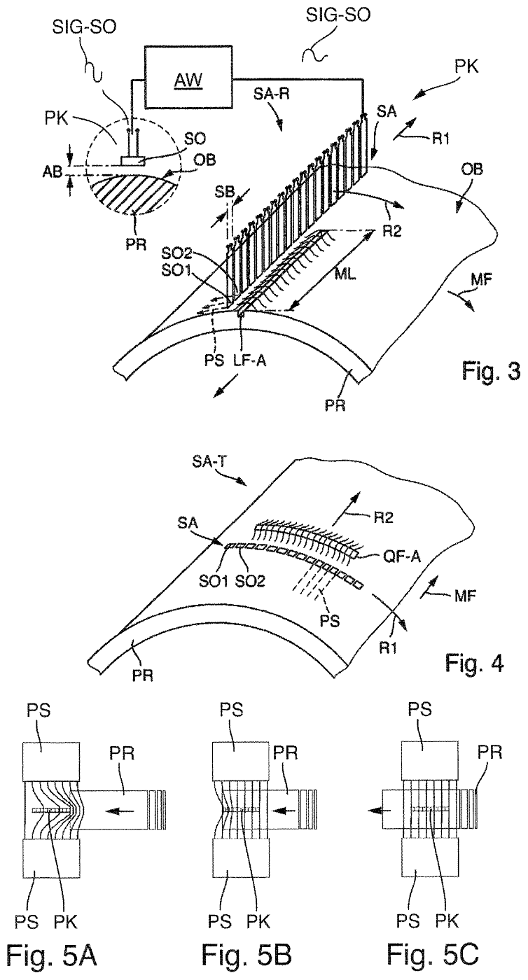

The ring yoke together with the pole shoes PS and the test heads PK rotates during the testing at rotational speeds of between approximately 30 and approximately 1200 min⁻¹, depending on the type of rotating subsystem. The pipe to be tested is simultaneously transported forwards in the passage direction at a test speed (for example up to 3 m/s or more). In this case, the test heads slide on the pipe surface and scan the latter in an uninterrupted fashion on a helical path. The probes SO of the probe array are arranged within the test heads at a small test distance AB from the surface OB of the test material, which test distance can be for example of the order of magnitude of 0.2 mm to 2 mm (c.f. FIG. 3). By virtue of the fact that the magnetic field lines extend in the circumferential direction, this testing is particularly sensitive to longitudinal faults LF-A on the pipe exterior side and longitudinal faults LF-I on the pipe interior side which maximally disturb the magnetic flux in the circumferential direction and generate strong leakage flux fields as a result (FIG. 2).

In the case of the stationary system (FIG. 1B) for transverse fault testing, use is made of a DC field magnetization device, not illustrated in more specific detail, which generates a magnetic field MF in the longitudinal direction of the pipe passing through. Two rings of probe arrays comprising probe arrays SA arranged intermittently in the circumferential direction are arranged around the test specimen in a ring-shaped manner and scan the test specimen in the longitudinal direction thereof during continuous testing. Since the magnetic flux extends in the longitudinal direction, it is disturbed to a particularly great extent by transverse faults extending in the circumferential direction on the exterior side (QF-A) and transverse faults on the interior side (QF-I), such that this arrangement for transverse fault testing has a high test sensitivity.

The electrical signals SIG-SO of the leakage flux probes of the probe arrays, i.e. the probe signals, are fed to a common evaluation device AW, in which the defects are qualified. Since the probe signals during testing are caused by a fault or defect and are characteristic thereof, the probe signals here are also referred to as “fault signals” or “test signals”.

Each type of fault causes particular fault type-specific leakage flux fields, the properties of which can be identified from the signal waveform and the frequencies contained in the signal. FIG. 2 shows for example a sectional view through a pipe perpendicular to the longitudinal direction and also the magnetic field lines of the magnetization field MF that extend in the circumferential direction. An external fault LF-A extending in the longitudinal direction generates a leakage flux field SF-A concentrated relatively narrowly in the vicinity of the external fault. By contrast, an internal fault LF-I of identical dimensions that extends in the longitudinal direction generates a less sharp, more greatly spatially smeared or expanded or widened leakage flux field SF-I with a smaller amplitude on the pipe exterior side. Typical signal waveforms of the probe signals when a probe passes over in the circumferential direction are shown in each case above the leakage flux fields. In this case, the y-axis corresponds to the signal amplitude A and the x-axis corresponds to time t or to the location during circulation of the probe.

Details concerning the design of the probe arrangements for the rotating system (FIG. 3) and the stationary system (FIG. 4) will now be explained with reference to FIGS. 3 and 4. The probe arrangement SA-R for the rotating system has a multiplicity of nominally identical individual probes SO1, SO2 etc., which form a probe array SA and are arranged in a straight series along a first direction R1, which extends parallel to the longitudinal axis of the pipe. The probe array SA is installed in a test head PK (cf. e.g. FIG. 7). In a rotating system, the probe arrangement moves as a whole in the circumferential direction of the test specimen around the test specimen in a second direction R2, which extends perpendicularly to the first direction R1. As a result of the simultaneously proceeding longitudinal movement of the test specimen PR, each of the individual probes SO1, SO2 scans a relatively narrow test track PS extending spirally around the test specimen, the test track extending obliquely with respect to the first and second directions. All the probes of the probe array jointly scan a relatively high test width with a multiplicity of test tracks parallel to one another.

A corresponding arrangement arises in the case of the probe arrangement SA-T for transverse fault testing (cf. FIG. 4). The probe arrangement SA-T has a multiplicity of individual probes SO1, SO2 etc., which are arranged next to one another in series in the first direction R1, the first direction here corresponding to the circumferential direction of the test material PR. The probe arrangement is stationary, while the test material moves parallel to its longitudinal direction, such that the probe array scans the test specimen surface in a scanning direction corresponding to the second direction R2 perpendicular to the first direction R1. Here, too, each individual probe covers a relatively narrow test track PS, the totality of the test tracks in the circumferential direction producing a many times greater test width of the probe arrangement. The magnetic field MF extending in the longitudinal direction of the pipe is forced out of the test specimen material at a transverse fault QF-A and is detected by means of the probes of the probe array SA.

The magnitude or the amplitude of a fault signal (leakage flux signal) depends not only on the constitution of the fault, but also on the strength of the magnetic field in the test specimen, that is to say for example in the pipe wall, at the location of the fault. In order that during pipe testing, for example, the same fault at different longitudinal positions of the pipe generates the same fault signal, the magnetization would have to be constant over the pipe length. Experience shows that this is not the case, however. Primarily at the pipe ends, the magnetization locally present deviates from the magnetization in the pipe centre (viewed in the longitudinal direction). Wall thickness variations can also lead to fluctuations in the magnetization. Moreover, dynamic effects can arise as the magnetic fields build up and dissipate, in particular upon a pipe entering a test apparatus and upon exiting.

As illustrated schematically in FIGS. 5A-5C, as a result of the pipe PR or the test specimen PR entering between the pole shoes, the magnetic field lines from the air are drawn into the more highly permeable ferromagnetic pipe (FIG. 5A). This leads to a higher magnetization at the pipe ends. It is only when a certain length of the pipe projects from the pole shoe again (FIG. 5C) that the magnetization attains its nominal value at a large distance from the pipe ends. Depending on the rapidity of the advancing speed of the pipe, the attainment of the nominal magnetization may be delayed on account of induction effects or as a result of control of the coil current or may be influenced in some other way.

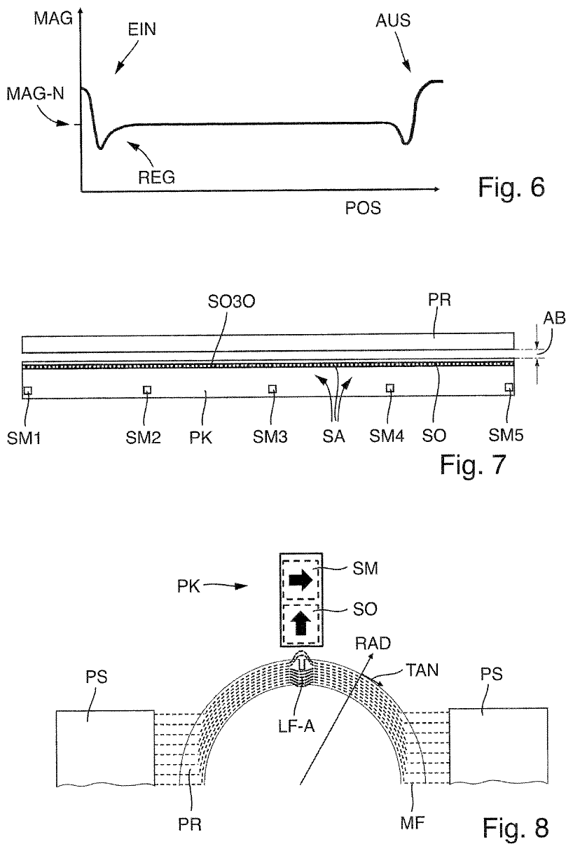

FIG. 6 schematically shows the exemplary profile of the strength of the magnetization when a pipe passes through a test apparatus. The position POS in the longitudinal direction (first direction R1) is indicated on the abscissa, and a measure-which will be additionally explained later-of the strength of the magnetization MAG is indicated on the ordinate. Upon entry EIN, firstly a higher magnetization arises on account of the field line concentration, and then falls sharply on account of transient processes. The current regulation REG of the magnetic field coils then counteracts that, with the result that the desired nominal magnetization MAG-N is present with only minor fluctuations over the majority of the passage section or pipe length. Upon exiting AUS, effects of the control and of the field line concentration are then manifested again (cf. FIGS. 5A-5C).

The fluctuations of the magnetization inter alia upon entering and exiting lead to fluctuations and undefined states with regard to the test sensitivity, inter alia because it is not clear whether a strong fault signal is attributable to a particularly large fault or to a strong magnetization. Since the test results at the pipe ends are therefore not sufficiently reliable, this is referred to as “untested ends”.

An explanation is given below of the way in which, in accordance with one embodiment of the invention, a uniform test sensitivity can be obtained substantially over the entire pipe length. In this case, the uniform test sensitivity is essentially produced by continuously detecting the magnetization state of the test specimen and normalizing or compensating for the fault signal amplitudes with this magnetization state.

Some design measures that are realized in the exemplary embodiment in order to contribute to making the test sensitivity more uniform will be explained with reference to FIGS. 7 and 8. FIG. 7 shows a schematic side view of a test head PK arranged in a test configuration at a distance AB from the surface of the test specimen PR. The probe array SA is fitted on the side facing the test specimen, and has a straight series comprising a large number of leakage flux probes SO or test probes SO, e.g. 40 or more, or 70 or more, in the case of the example between 90 and 100 mutually identical leakage flux probes.

A smaller number of magnetic field probes SM1 to SM5 are arranged at a small distance behind the probe array, specifically likewise in a straight series. The magnetic field probes here are arranged at uniform distances from one another, but the distances can also be non-uniform, in particular smaller at the end regions than in the centre. The arrangement is chosen such that each of the leakage flux probes is assigned at least one magnetic field probe which can generate magnetization signals that represent a measure of the magnetization state of the test material in the region of the leakage flux probe. For example, by way of an interpolation, the magnetization at the location of the leakage flux probe SO30 can be ascertained with the aid of the magnetization signals of the two closest magnetic field probes SM2 and SM3, as will be additionally explained later.

FIG. 8 shows a schematic view of the arrangement illustrated in FIG. 7 in the longitudinal direction of the pipe. The test head PK here is shown directly above a longitudinal fault LF-A on the exterior side of the pipe.

The test head PK shown is designed to ascertain a measure of the magnetization of the test specimen by measuring a field component present parallel to the test material surface and parallel to the main magnetization direction, which field component may be designated here as a parallel component. To put it more precisely, the so-called tangential field or T-field is measured. The measured value of the magnetization signal is therefore also designated as a T-field value. The tangential field TAN corresponds to that component of the magnetic field strength at the test specimen surface which corresponds to that parallel component which extends tangentially with respect to the pipe, that is to say in a plane—which is perpendicular to the pipe longitudinal axis—parallel to the surface and parallel to the field lines of the magnetic field MF extending in the circumferential direction. Orthogonally thereto, that is to say in the direction of the normal to the pipe, there extends the radial component RAD of the magnetic field that is measurable in the region of the surface.

According to the inventors' insights, the measurement of the tangential field during testing for longitudinal faults e.g. on pipes is particularly well suited to determining the magnetization since the proportionality factor between the magnetization in the test material, that is to say here in the interior of the pipe material, and the T-field near the pipe surface corresponds to the ratio of the magnetic permeabilities of air (μ_{L}) and the pipe material (μ_{R}).

In the case of a rotating system, the main magnetization direction ideally extends exactly perpendicularly to the longitudinal axis of the pipe along the pipe circumference. Primarily during testing for defects that are not aligned exactly with the longitudinal axis of the pipe, deviations from the ideal alignment of the magnetic field lines cause a variation of the leakage flux signal that can decrease the exactness of the test result. A normalization of this variation can be achieved by additional measurement of that component of the magnetic field which is substantially perpendicular to the main magnetization direction and parallel to the longitudinal axis of the pipe. This component may be designated as an orthogonal component since it is oriented perpendicularly to the main magnetization direction. In the present case, it may also be designated as an axial component since it is parallel to the axial direction of the test material in the case of this measurement configuration. This component can be detected by one or more additional magnetically sensitive probes. In a further embodiment, the same magnetic field probe that detects the parallel field can also detect the components of the magnetization state that are perpendicular to the main magnetization direction, or else the absolute value and the angle of the magnetization state. If the magnetization is thus detected in two directions that are orthogonal to one another or extend obliquely with respect to one another and lie within a tangential plane (lying parallel to the test material surface), such effects can also be detected as well and taken into account in the fault signal normalization.

By contrast, the leakage field probes (test probes, fault probes) SO are designed such that they measure the radial component RAD of the magnetic field strength at the surface. This is formed primarily by the leakage flux at defects, namely where the magnetic field lines are forced out of the pipe material by a defect. In FIG. 8, the different sensitivity directions of the leakage flux probe (measurement of the radial component) and of the magnetic field probes (measurement of the T-field) are characterized by arrows.

The leakage flux probes SO and the magnetic field probes SM here are of the same probe type, namely Hall probes. They are structurally identical to one another, but differ from one another in the orientation of their main sensitivity direction (arrows in FIG. 8), that is to say the direction of maximum sensitivity. A further difference is that the signals for the T-field are detected by DC coupling (DC field coupling), while the leakage flux probes (probes for fault detection) operate with AC coupling (AC field coupling), that is to say detect only the change in the leakage fields.

The magnetic field probes (or T-field probes) can be positioned in the test head for example as follows: a central magnetic field probe SM3 in the centre, one each (SM1, SM5) at each of the axial ends of a probe array and one each (SM2, SM4) between the magnetic field probes at the ends and the central magnetic field probe. Five magnetic field probes may thus be sufficient. Before the positions of these T-field probes are defined, the progression of the tangential field in an axial direction should be known for the pole shoes, air gaps and pipe dimensions used. Depending thereon, it may be expedient, for example, to provide non-uniform distances instead of uniform axial distances (cf. FIG. 7) between the magnetic field probes, by virtue of the magnetic field probes being seated closer together in the axial edge regions.

In contrast to the leakage flux probes SO, which should be arranged as near to the test specimen surface as possible for the fault detection in order to detect high-frequency field changes, the magnetic field probes can be at a larger distance from the test specimen because they detect rather low-frequency field changes.

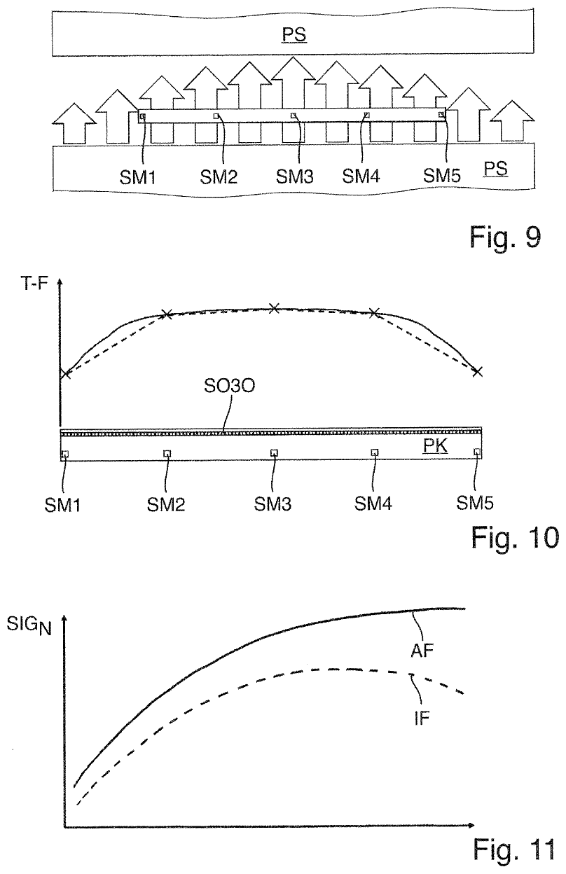

Design aids concerning the arrangement of magnetic field probes will now be explained with reference to FIGS. 9 and 10. For the T-field compensation sought (in order to make the test sensitivity more uniform), an associated T-field value is intended to be present for each leakage flux probe SO. In the case of five magnetic field probes SM1 to SM5, the T-field values for those leakage flux probes which are not arranged directly beneath a magnetic field probe are interpolated.

In this respect, FIG. 9 shows a test head PK between two pole shoes PS. The magnetic field generated in the region of the test head varies in an axial direction, the magnetic field strength (illustrated by the length of the arrows) being greater in the central region than in the vicinity of the axial ends.

FIG. 10 shows a corresponding diagram showing the dependence of the measured T-field T-F on the location along the test head. The crosses represent the magnetization signals (T-field values) of the magnetic field probes. The dashed lines represent linearly interpolated T-field values, and the solid line represents the actual T-field profile. While the interpolated values are close to the actual values in the central region (magnetic field probes SM2, SM3 and SM4) larger deviations arise in the region of greater axial gradients of the magnetic field strengths near the pipe ends. Said deviations can be reduced in the case of the example by the second and fourth magnetic field probes each being positioned nearer to the ends (dashed position), such that non-uniform distances between magnetic field probes can arise in the axial direction.

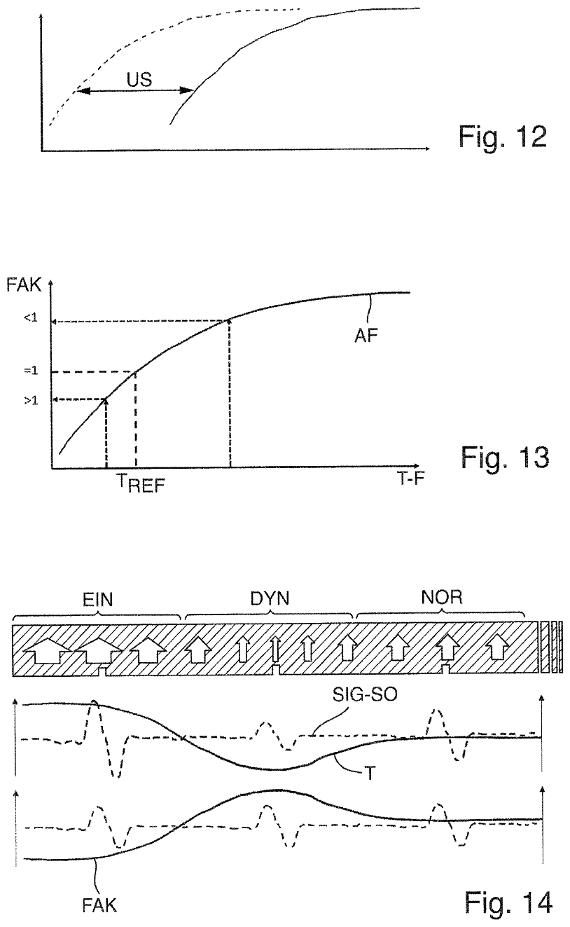

The measures for compensating for the axially unequal magnetization in the exemplary embodiment will now be explained with reference to FIGS. 11 to 13. The method takes account of the fact that the varying magnetization of the pipe wall in the axial direction leads to fault signals of different magnitudes for identical faults. The magnitude of the fault signal (amplitude of the fault signal) for different magnetizations is corrected with the aid of the measurement of the T-field by means of the magnetic field probes SM or with a factor calculated from them.

In the method, a (at least one) compensation curve is ascertained (cf. FIG. 11). Correlation measurements are carried out for this purpose. During T-field correlation, the test probes cyclically detect two correlation faults having known dimensions, namely one internal fault and one external fault, while the current intensity for the field coils (or measurement windings MW) at the pole shoes is increased from a minimum value to a maximum value. For each current intensity that is set, the test head passes over the correlation faults at least once, and the leakage field signals (fault signals) and the associated T-field values are recorded in the process. FIG. 11 shows a schematic diagram in which the current intensity for the field coils or the associated T-field T-F is recorded on the abscissa and a normalized signal strength SIGN for the external fault (solid line AF) and the internal fault (dashed line IF) is recorded on the ordinate.

The T-field correlation thus results in two pairs of values for each T-field, namely the fault signal (external fault) over the T-field value and the fault signal (internal fault) over the T-field value. From the measured pairs of values, the compensation curve here for AF or IF shown can then be interpolated, which assigns a compensation value for the fault signal to each T-field value.

It is found that there is variation of the measured T-field values for identical current intensities or identical magnetization states in the axial direction. The variation can be influenced by different pole shoe geometries. In the case of many conventional pole shoes, the T-field values may be smaller for example at the axial edges than in the centre. The investigations by the inventors show that independently of this axial variation, the profile of the compensation curve, that is to say the shape thereof, appears to be substantially independent of the axial position, that is to say independent of the test head position at which (the magnetic field probe by means of which) the T-field was measured.

In the method, a so-called displacement value is furthermore ascertained. FIG. 12 schematically illustrates a displacement VS by a displacement value between two compensation curves, the solid line corresponding to an external fault in the region with higher magnetic field strength and the solid line corresponding to the same external fault in a region of lower magnetic field strength.

Since the shape of the compensation curve, indicating the functional relationship between the T-field strength and the resulting signal amplitude recorded on the y-axis, does not change at different advancing positions, the T-field compensation in the exemplary embodiments manages with only two compensation curves, namely one for external faults and one for internal faults. In addition, the displacement value is ascertained for each of the leakage flux probes. The difference between the T-field value of the leakage flux probe and the T-field value of the central T-field probe can be chosen as the displacement value. The displacement value VS should be ascertained separately for each test head.

In the method, the T-field value (corrected by the displacement value) of the respective leakage flux probe and also a reference value REF are utilized for the T-field compensation. The reference value is chosen for example such that it corresponds to the T-field value for which the factor for the correction of the signal amplitude is equal to 1. The T-field value of the central magnetic field probe from the correlation fault for nominal current intensity is preferably chosen as the reference value. In the case of T-field values that are above the reference value, the fault signals of the corresponding leakage flux probes are provided with a factor of less than 1 (<1), and in the other case (T-field value below the reference value) with a factor of greater than 1 (>1). FIG. 13 illustrates this for the curve of the external fault; the abscissa represents the strength of the T-field, and the ordinate represents the factor FAK, which is equal to 1 for the reference value T_{REF}.

The effect of the compensation strategy will now be explained on the basis of a schematically illustrated example with reference to FIG. 14. The upper part shows the test specimen PR, on which a longitudinal external fault LF-A has been introduced as a correlation fault. The arrows in the test specimen represent the magnetization, and the thickness of the arrows represents the strength of the magnetization, which varies axially. The left-hand part EIN is intended to represent the entry phase, the middle part illustrating DYN is intended to represent the dynamic effects associated with the control near the time of entry, and the right-hand part NOR is intended to represent the relationships at a greater distance from the pipe ends, where a stable normal state of the magnetization arises.

In the diagram illustrated underneath, the solid line T shows the amplitude of the measured T-field, that is to say the strength of the magnetization signal of the magnetic field probes. The dashed line SIG-SO schematically represents the fault signal, that is to say the leakage flux signal of the leakage flux probes SO. The size of the fault in the test specimen is the same in all three cases, and so ideally (given axially uniform magnetization) the same fault signal amplitudes should occur in all three situations.

In actual fact, however, the curve SIG-SO shows that there is a relatively large fault signal amplitude in the entry phase EIN, in which the magnetization is relatively high and, accordingly, the measured T-field is relatively high. In the region of the dynamic effects or transient processes, where relatively low magnetic field strengths may occur, the fault signal is distinctly weaker than during the entry phase. It is only at a greater distance from the pipe end that the fault signal is established with its “true” amplitude corresponding to the geometry of the fault.

In experiments in which, in the region of the pipe ends, in each case two longitudinal external faults of identical size were introduced at different distances from the pipe end (100 mm and 250 mm), the fault closer to the pipe end generated a fault signal up to 6 dB higher than that at the position at a greater distance from the pipe end. A similar situation was also observed for internal faults.

The bottom diagram in FIG. 14 then shows the effect of the compensation. The solid line FAK there represents the above-explained factor indicating the value by which the measured fault signal amplitude must be multiplied in order to attain the true amplitude of the fault according to the compensation. During entry, this factor is below that value which arises in the normal state (on the right in the diagram). As a result, the amplitude of the fault signal is reduced. In the region DYN of the dynamic effects the fault signal is slightly amplified, and in the region of the normal relationships the factor is approximately one, which means that here the “correct” signal amplitude is measured directly.

1-17. (canceled)

18. A method for leakage flux testing of ferromagnetic test material in order to detect defects, comprising:
magnetizing a test volume of the test material via an external magnetic field in order to generate a magnetization state of the test volume that is characterizable by a magnetization;
scanning a surface of the test material via a probe arrangement comprising at least one magnetic field-sensitive leakage flux probe in order to detect magnetic leakage fields caused by defects, the leakage flux probe, during the scanning, being held at a finite test distance from the surface of the test material and generating electrical probe signals that are a measure of the strength of the leakage field;
determining the magnetization state of the test volume in a region of the leakage flux probe using at least one magnetic field probe in order to generate magnetization signals that represent a measure of the magnetization state of the test material in the region of the leakage flux probe;
normalizing the probe signals via the assigned magnetization signals in order to ascertain normalized probe signals; and
evaluating the normalized probe signals in order to qualify the defects.

19. The method according to claim 18, wherein
a magnetic field-sensitive probe, separate from the leakage flux probe and provided in addition to the leakage flux probe, is used as the magnetic field probe.

20. The method according to claim 18, wherein
in order to ascertain the magnetization state, a parallel component of the magnetic field that is directed substantially parallel to the surface of the test material and parallel to a main magnetization direction is measured in a close range around the leakage flux probe.

21. The method according to claim 18, wherein
the test material is a ferromagnetic pipe, a magnetic field component directed substantially tangentially to the surface of the test material being measured in order to detect the magnetization state.

22. The method according to claim 18, wherein
a DC field component of the magnetization signal is ascertained and utilized for normalizing the probe signal.

23. The method according to claim 18, wherein
the probe signal of a leakage flux probe has a signal amplitude, and
in order to normalize the probe signal, the signal amplitude is multiplied by a compensation factor that at least partly compensates for a magnetization dependence of the test sensitivity, the compensation factor being substantially inversely proportional to the strength of the magnetization of the test volume scanned by the leakage flux probe.

24. The method according to claim 18, further comprising:
carrying out calibration measurements on a correlation portion of the test material, said correlation portion being equipped with at least one correlation fault, in order to ascertain a compensation curve that describes a functional relationship between a magnetization state of the test material in the case of external magnetic fields of different strengths, corresponding magnetization signals of a magnetic field probe and a signal amplitude of the probe signal that is generated by a standard defect, and
deriving compensation factors for normalizing probe signals from the compensation curve during the evaluation of the probe signals.

25. The method according to claim 24, further comprising:
taking account of a variation of the magnetization state depending on an axial position of a test portion to be tested when ascertaining the correction factor to be applied for the test portion by a procedure in which, when ascertaining the correction factor, an axial offset between the calibration portion and the test portion is ascertained and the correction factor is modified depending on the offset.

26. The method according to claim 24, wherein
the correction factor for an axial position in a test portion is ascertained on the basis of a displaced compensation curve, the displaced compensation curve having the curve shape of the compensation curve ascertained in the calibration portion, said compensation curve being displaced by a displacement value corresponding to the axial offset relative to the compensation curve ascertained in the calibration portion.

27. The method according to claim 18, wherein
the probe arrangement has a probe array comprising a multiplicity of leakage flux probes arranged next to one another in a first direction, two or more magnetic field probes arranged at a distance from one another in the first direction preferably being provided in order to detect the magnetization state, the number of magnetic field probes preferably being less than the number of leakage flux probes.

28. An apparatus for leakage flux testing of ferromagnetic test material in order to detect defects, comprising:
a magnetization device for magnetizing a test volume of the test material;
a probe arrangement comprising at least one leakage flux probe for detecting magnetic leakage fields caused by defects, the leakage flux probe being configured, during the scanning, to be held at a finite test distance from a surface of the test material and to generate electrical probe signals having a fault signal amplitude dependent on the leakage flux, said probe signals being a measure of the strength of the leakage field;
an evaluation device for evaluating the probe signals in order to qualify the defects;
at least one magnetic field probe for generating magnetization signals that represent a measure of the magnetization state of the test material in the region of the leakage flux probe; and
wherein the evaluation device is configured to carry out a normalization of the probe signals by the assigned magnetization signals in order to ascertain normalized probe signals, and to evaluate the normalized probe signals in order to qualify the defects.

29. The apparatus according to claim 28, wherein
the magnetic field probe is a magnetic field-sensitive probe separate from the leakage flux probe and provided in addition to the leakage flux probe.

30. The apparatus according to claim 28, further comprising:
at least one test head in which a probe arrangement comprising at least one leakage flux probe and also at least one magnetic field probe are arranged in a fixed spatial relationship with respect to one another.

31. The apparatus according to claim 28, wherein
the leakage flux probe is arranged to detect a normal component of the leakage field that is oriented substantially perpendicularly to the surface of the test specimen, and/or
the magnetic field probe is arranged to detect a parallel component of the magnetic field that is directed substantially parallel to the surface of the test material and parallel to the main magnetization direction.

32. The apparatus according to claim 28, wherein
the probe arrangement has a probe array comprising a multiplicity of leakage flux probes arranged next to one another in a straight series in a first direction, two or more magnetic field probes arranged at a distance from one another in a straight series in the first direction being provided in order to detect the magnetization state.

33. The apparatus according to claim 28, wherein
a number of magnetic field probes is less than a number of leakage flux probes, the number of leakage flux probes being at least five times as high as the number of magnetic field probes, and/or
the leakage flux probes are arranged at uniform distances from one another, and
the magnetic field probes are arranged at non-uniform distances from one another, a density of magnetic field probes being greater in end regions of the probe arrangement than in a central region of the probe arrangement.

34. The apparatus according to claim 28, wherein
the leakage flux probes are arranged on a side of the test head that is to be directed towards the test specimen, and
the magnetic field probes are arranged at a distance behind the leakage flux probes.
